(19) United States
(12) Patent Application Publication
(10) Pub. No.: US 2005/0095380 A1
(43) Pub. Date: May 5, 2005

(54) Insulated subsea pipe, and materials and methods for applying thermal insulation to subsea pipe

(76) Inventors: Lou Watkins, Stoughton, MA (US); William Cuming, Avon, MA (US)

Correspondence Address: Gauthier & Connors LLP, 225 Franklin Street, Suite 3300, Boston, MA, 02110, US

(21) Appl. No.: 10/847,645

(22) Filed: May 17, 2004

Related U.S. Application Data
(60) Provisional application No. 60/471,075, filed on May 16, 2003.

(51) Int. Cl. B32B 1/08

(52) U.S. Cl. 428/36.5; 428/36.91

(57) ABSTRACT

A plurality of concentric plastic tubes are drawn over a steel flowline pipe, with the annuli thus formed between the successive layers of tubing filled with an appropriate insulating material to form a length of pipe suitable for use in a subsea pipeline. The length of steel flowline pipe is at least partially encased lengthwise by a first insulating core of interstitial material. A first length of polymeric tubing is coaxial with the length of steel pipe and radially separates the first insulating core and a second insulating core of interstitial material. A second length of polymeric tubing is radially exterior to the second insulating core, and provides a protective coating for the pipe. Advantageously, the insulated length of pipe may be formed without extruding or molding, and as a result expensive dies and molds are not required.

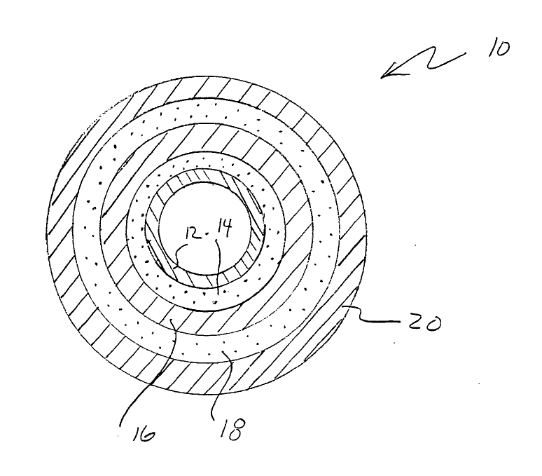

### CLAIM OF PRIORITY

This application claims priority to U.S. Provisional Patent Application designated Ser. No. 60/471,075 filed May 16, 2003 and entitled “Insulated Subsea Pipe, and Materials and Methods for Applying Thermal Insulation to Subsea Pipe”.

### BACKGROUND OF THE INVENTION

The present invention relates to the field of insulated subsea pipe, and in particular to insulated subsea pipe that includes a plurality of concentric plastic tubes drawn over a steel flowline pipe with thermal insulation disposed there between, and materials and methods for applying thermal insulation to subsea pipe.

As offshore oil and gas reserves are discovered in deeper water, the problem of conveying these valuable materials to a collection point becomes more acute. The most common method is to pump the hydrocarbons through submarine pipelines. However, if the naturally warm liquids and gases are overly cooled by the surrounding sea water, they may congeal and form precipitates (paraffins and/or hydrates) that can block the flow. For this reason, subsea pipelines are frequently insulated to retain the heat of the well products. The insulating materials used for this purpose range from syntactic foam (e.g., a castable plastic resin, such as epoxy, filled with tiny glass microspheres) to polypropylene extruded in the field directly onto the pipeline. The disadvantages of conventional insulating materials are: (1) they are expensive, and (2) they take too long because of the time lag involved, both in obtaining custom tooling, and in applying the insulation.

U.S. Pat. No. 6,058,979 assigned to the assignee of the present invention and hereby incorporated by reference, discloses an insulated pipeline that includes a length of steel pipe coated with syntactic foam and having an outer concentric plastic pipe that provides a protective casing. The pipeline disclosed therein employs an insulting core of syntactic foam between the steel pipe and the protective outer plastic pipe.

A problem with the prior art solutions is that they are relatively expensive. Therefore, there is a need for low cost insulated lengths of pipe for subsea oil/gas lines.

### SUMMARY OF THE INVENTION

A multiplicity of concentric plastic tubes are drawn over a steel flowline pipe, with the annuli thus formed between the successive layers of tubing filled with an appropriate insulating material to form a length of pipe suitable for use in a subsea pipeline. The length of steel flowline pipe is at least partially encased lengthwise by a first insulating core of interstitial material. A first length of polymeric tubing is coaxial with the length of steel pipe and radially separates the first insulating core and a second insulating core of interstitial material. A second length of polymeric tubing is radially exterior to the second insulating core, and provides a protective coating for the pipe.

Advantageously, the insulated length of pipe can be formed without extruding or molding, and as a result expensive dies and molds are not required.

These and other objects, features and advantages of the present invention will become more apparent in light of the following detailed description of preferred embodiments thereof, as illustrated in the accompanying drawings.

### BRIEF DESCRIPTION OF THE DRAWING

The FIGURE is a cross-sectional illustration of a length of insulated pipe.

### DESCRIPTION OF THE INVENTION

The FIGURE is a cross-sectional illustration of a length of pipe 10 suitable for use in a subsea pipeline. The length of pipe 10 includes an inner pipe 12 that is typically steel and has a diameter of about 4-6 inches and a typical wall thickness of about 0.25 to 0.5 inches. The pipe 12 is often referred to as a “flow line” because of oil or gas, or in most cases a combination of the two pass through the pipe. To protect the pipe 12 from the corrosive effects of sea water, a thin anticorrosion barrier of plastic film or paint like coating covers the exterior of the pipe 12. Mainly outside of that is a first insulating core 14 of interstitial material. The insulated length of pipe 10 also includes a polymeric inner casing 16 that is coaxial with the steel pipe 12. The inner casing 16 may be for example a polypropylene pipe, which is approximately 12 inches in diameter. The length of the pipe 10 also includes a second insulating layer 18 of interstitial material radially exterior to the inner casing 16, and radially interior to a protective outer casing 20. The protective outer casing 20 may also be a polymeric pipe, such as for example a polypropylene pipe. Significantly, the insulated pipe is characterized by multiple layers of interstitial material and polymeric piping.

The present invention provides an improved insulated length of pipe and an improved method of creating thermal insulation that is both less costly and faster to apply than previous systems.

The functions of the “interstitial” or “interleaving” material include: (i) bonding the layers of plastic tubing to each other and to the steel pipe, (ii) forming a waterproof seal between the layers, (iii) contributing to the thermal insulating effect, and (iv) permitting as much relative motion as possible, contributing to flexibility. It is not strictly necessary that a single interlayer material be used—a combination or gradation of different materials may be better in some cases.

Epoxy/glass syntactic foam is one choice for an interlayer material, but any number of alternatives are also possible. For example, rubber or plastic elastomer, asphalt or asphaltic mastics, adhesives, oils or other liquids, gels, and wax (paraffin). “Dry” materials candidates, such as sand, glass microspheres, or clay and gravel may also be used. The interstitial material is preferably a relatively inexpensive, pliable material that can be poured or injected into the annular spaces formed between the layers. Water alone, provided it is baffled to prevent convection, may also work.

The insulated length of pipe includes a plurality of commercially available plastic tubes, slipped over the steel pipe in a concentric series of layers, of preferably standard sizes selected to provide clearance between the pipe and the various layers. The resulting multiplicity of annular spaces are then filled with the interstitial material. For example, syntactic foam may be injected under pressure to establish concentricity, bond the layers together, and confer a high degree of thermal resistance. The resulting structure is tough and waterproof. Because standard commercial tubing is preferably used, costs are reduced and speed of application is increased.

Commercial extruded plastic tubing is readily available in a wide range of sizes and materials, including polyvinylchloride (PVC), polyethylene, and polypropylene (the latter two known collectively as polyolefins). Any of the named materials could be useful in the subject invention, as well as many other polymers. Similarly, the syntactic foam component may be selected from a large number of possible combinations, including epoxy, polyester, polystyrene, and polyurethane plastic resins, and glass, ceramic, and plastic microspheres and possibly fiberglass macrospheres. In every case, the appropriate materials will be selected on the basis of service conditions.

The insulated length of pipe 10 can be manufactured without die and molds, since the foam can be placed within the annuluses formed between the concentric pipes, and then allowed to cure.

Although the present invention has been shown and described with respect to several preferred embodiments thereof, various changes, omissions and additions to the form and detail thereof, may be made therein, without departing from the spirit and scope of the invention.

1. A insulated length of pipe suitable for subsea operation, said insulated length of pipe comprising:
a metallic flowline;
a first plastic tube co-axial with and drawn over said metallic flowline to form a first annulus between said metallic flowline and said first plastic tube;
a first layer of insulating interstitial material within said first annulus;
a second plastic tube co-axial with said metallic flowline and drawn over said first plastic tube to form a second annulus between said first plastic tube and said second plastic tube; and
a second layer of insulating interstitial material within said first annulus.

2. The insulated length of pipe of claim 1, wherein said first layer of insulating material comprises syntactic foam.

3. The insulated length of pipe of claim 1, wherein said first layer of insulating material comprises rubber or plastic elastomer.

4. The insulated length of pipe of claim 1, wherein said first layer of insulating material comprises asphalt or asphaltic mastics.

5. The insulated length of pipe of claim 1, wherein said first layer of insulating material comprises a liquid.

6. The insulated length of pipe of claim 1, wherein said first layer of insulating material comprises paraffin wax.

7. The insulated length of pipe of claim 1, wherein said first plastic tube comprises polyolefin.

8. The insulated length of pipe of claim 1, wherein said first plastic tube comprises polyvinylchloride.

9. An insulated length of pipe, comprising:
an inner pipe;
a first outer poly sleeve co-axial with said inner pipe;
a first spacer for spacing said inner pipe and said outer poly sleeve to define a first annulus;
a first insulating core within said first annulus that encases lengthwise said inner pipe;
a second outer poly sleeve co-axial with said inner pipe;
a second spacer for spacing said first outer poly sleeve and second outer poly sleeve to define a second annulus; and
a second insulating core within said second annulus that encases lengthwise said first outer poly sleeve.
a first binder that fills interstices in said annulus.

10. The insulated length of pipe of claim 9, wherein said first layer of insulating material comprises syntactic foam.

11. The insulated length of pipe of claim 9, wherein said first layer of insulating material comprises rubber or plastic elastomer.

12. The insulated length of pipe of claim 9, wherein said first layer of insulating material comprises asphalt or asphaltic mastics.

13. The insulated length of pipe of claim 9, wherein said first layer of insulating material comprises a liquid.

14. The insulated length of pipe of claim 9, wherein said first layer of insulating material comprises paraffin wax.

15. The insulated length of pipe of claim 11, wherein said first plastic tube comprises polyolefin.

16. The insulated length of pipe of claim 11, wherein said first plastic tube comprises polyvinylchloride.
